(19) United States
(12) Patent Application Publication
(10) Pub. No.: US 2003/0006656 A1
(43) Pub. Date: Jan. 9, 2003

(54) Display devices

(76) Inventor: Frank J. Prineppi, Freeport (BS)

Correspondence Address: FRANK J. PRINEPPI, PMB 341, 1323 SE 17th ST., FT. LAUDERDALE, FL, 33316, US

(21) Appl. No.: 09/897,076

(22) Filed: Jul. 3, 2001

(51) Int. Cl. H02K 37/00; H02K 11/00

(52) U.S. Cl. 310/68 R; 310/49 R

(57) ABSTRACT

A battery operated lightweight display device comprises a housing (22) containing an electrically operable stepper motor (1), the stepper motor including a magnetic rotor (6), the rotor having single or multiple magnetic pole pairs, a bi-polarisable stator (3) and associated coil (8); a drive circuit (2) for driving the stepper motor at high speed by means of discrete electric drive pulses; a gear train (18,19,20 and 21) drivingly connected between the rotor and a rotatable display support element (16); the display support element being adapted to support an object to be displayed (24) and rotated relative to said housing when the drive circuit and hence the stepper motor is energized by a battery.

This invention relates to display devices and in particular to electrically operable display devices which allow rotation of an item being displayed, such as an advertising sign used to promote merchandise.

Although rotating or rotatable display devices can be powered from a household electricity supply, it will be understood that the positioning of the device is therefore limited by the length of the supply cable, whereas effective advertising in large stores often requires the advertising sign being suspended from the ceiling or in some other eye-catching position. This has lead to battery operated display devices which are generally bulky and require several batteries in order for the DC motor to run non-stop for the required duration of an advertising promotion, which may be several months.

These DC motors are usually multi-pole commutator based devices, having heavy metal rotors with complex coils, brush assemblies and low friction bearings. As a result, the amount of components in such devices is quite high, making production and assembly relatively expensive. A further disadvantage is that DC motors with brushes suffer wear and become unreliable as dirt, dust and moisture builds up on the brushes and the commutator, thereby lowering the usable life of the display device, especially as battery voltage diminishes over time.

As will be appreciated, the combined weight of the motor and attendant batteries in the foregoing devices make them impractical to hang from a chosen position without a mechanical fixing to e.g. a ceiling panel by fasteners such as screws and bolts etc.

Similar considerations apply when the item to be displayed is intended to be viewed adjacent a generally structurally non-rigid member, such as in the case of a Christmas ornament hanging from a thin branch of a Christmas tree, whether a natural or artificial Christmas tree. To solve this problem small light-weight motors can be used such as those described in U.S. Pat. No. 5,568,970 and 5,954,418 the disclosures of each of which are incorporated herein by reference, powered from an adjacent socket of a conventional Christmas tree light string. However, even then the positioning of the ornament is still somewhat limited by the positioning of the light string which, in turn, has to be reasonably adjacent to a mains electric socket.

The present invention is derived in part from the realisation that there exists a need for a light-weight display device that can be attached to objects at almost any location including any part of a ceiling or branch of a Christmas tree, whilst at the same time permitting the object to be displayed to be slowly rotated continuously for very long periods.

As will be appreciated by those skilled in the art of motor manufacture and use, stepper motors are traditionally used to provide step-wise increments of e.g. clock or watch movements where electrical pulses transmitted to the north or south poles of the stator provide an incremental movement of the hands of the clock or watch, as the case may be. However, stopping the rotor at each successive pole position also uses up electrical energy which may be from the same pulse or a separate pulse where, in each case, there is a current drain in getting the rotor started and stopping it when it reaches its new pole alignment position at the end of each step.

In a known refinement of this kind of motor, the step-wise movement may be converted to a continuous sweep movement by broadening the bi-polarisable pole pieces through the use of a metal bridge piece so as to effectively broaden the face of the poles. In this configuration, the rotor will encounter diminished decelerating forces once it reaches pole alignment but does not stop so that continuous motion of the rotor occurs. However, this bridge piece has the effect of reducing the concentration of magnetic flux around each pole which therefore reduces the amount of energy transmitted to the rotor such that this kind of motor suffers from an inherent reduction in power output due to this reduced energy field.

The present invention is also derived from the realisation that by driving a stepper motor at an unusually high speed, typically 800 rpm, by the use of a drive circuit producing a required number of pulses per minute, particularly square wave pulses, advantage can be taken of the inertia generated thereby, such that through suitable reduction gearing it is possible to drive and therefore continuously rotate a support element such as a hook or turntable using very little electrical energy.

According to the invention there is provided a battery operated lightweight display device comprising or including a housing containing an electrically operable stepper motor, the stepper motor including a magnetic rotor, the rotor having single or multiple magnetic pole pairs, a bi-polarisable stator and associated coil; a drive circuit for driving the stepper motor at high speed by means of discrete electric drive pulses; a gear train drivingly connected between the rotor and a rotatable display support element; the display support element being adapted to support an object to be displayed and rotated relative to said housing when the drive circuit and hence the stepper motor is energised by a battery.

In this patent specification “light-weight” is intended to mean sufficiently light so as to enable the device to be e.g. stuck to an underside surface such as a ceiling panel by a self-adhesive pad, or hung from a resilient structure such as the branch of a Christmas tree without causing undue bending thereof. The term “high-speed” is intended to mean revolutions per minute in the 100's or 1,000's and the term “low-speed” is intended to mean revolutions per minute of no more than a few. The term “discrete electric drive pulses” is intended to mean relatively short bursts of electrical energy of duration so as not to substantially contribute to deceleration of the rotor as the poles thereof align themselves with the stator poles such that substantially all of the electrical energy of each drive pulse is only used to keep the rotor running at the relatively high speed in a manner analogous to a toy spinning top which may be occasionally whipped in order to maintain its speed of rotation.

In accordance with a preferred embodiment of the invention, as further described below, an object to be displayed such as an advertising sign, can be continuously rotated for, typically, 1,000 hours using only a small 1.5 v battery such that the combined weight of the battery, the motor, the gear train, the display device housing and the displayed object, can easily be secured to e.g. a ceiling through the use of an adhesive pad, assuming that the object being displayed is not itself very heavy.

Preferably, the drive circuit is in the form of a micro-circuit which includes an “H” bridge driver for sending short pulses to respective ends of the motor's coil to drive the rotor, which itself may preferably be in the form of a single pole pair or multiple pole pair ferrite annular rod having a centrally disposed output drive shaft.

In a further aspect of the invention each drive pulse from the “H” bridge driver is subdivided into a main drive pulse followed by a number of micro-pulses to thereby utilise less electrical energy and hence prolong the life of the battery even further.

Conveniently, the drive circuit may include an adjustable timing mechanism for the drive pulses for controlling their frequency and the length of each pulse over time, and in a preferred embodiment each drive pulse is subdivided into a main pulse to “kick” the rotor to a position approximately half way from one pole towards the next succeeding, but opposite, pole, followed by a series of mini-pulses which may conveniently be of decreasingly short duration as the rotor moves towards that pole so as to reduce or minimise energy that would otherwise be wasted due to the rotor's inherent inertial progress towards the pole as a result of the high speed of rotation thereof.

Conveniently, the drive circuit includes an adjustable timing mechanism for controlling the frequency and duration of the drive pulses. Alternatively, the frequency of the drive pulses may be preset to maintain after start-up a supply of drive pulses only sufficient to keep the rotor turning at a constant and relatively high speed relative to the display support element but not at maximum possible speed, thereby to minimise excess consumption of electrical energy.

The display support element may take the form of a hook onto which an object to be displayed is hung, in which case the housing may include a self-adhesive pad for suspending the display device from a planar surface such as a ceiling. Alternatively, the display support element may be a turntable onto which an object to be displayed is placed, such as watches or jewellery.

The invention will now be described by way of example only, with reference to the accompanying drawings, in which:

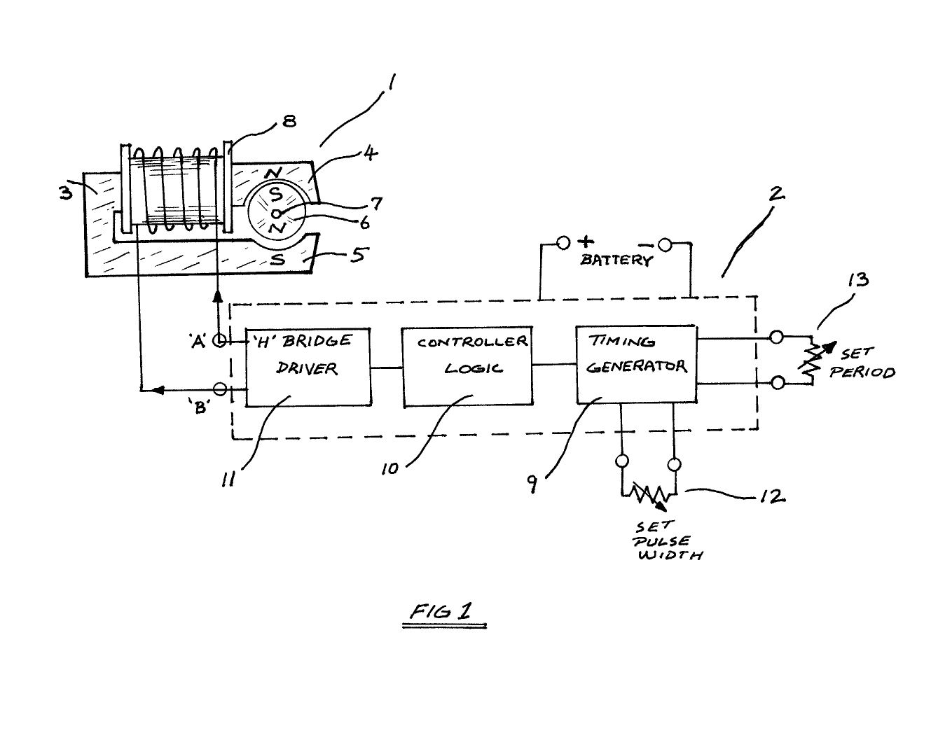

FIG. 1 is a schematic view of a stepper motor and associated drive circuit;

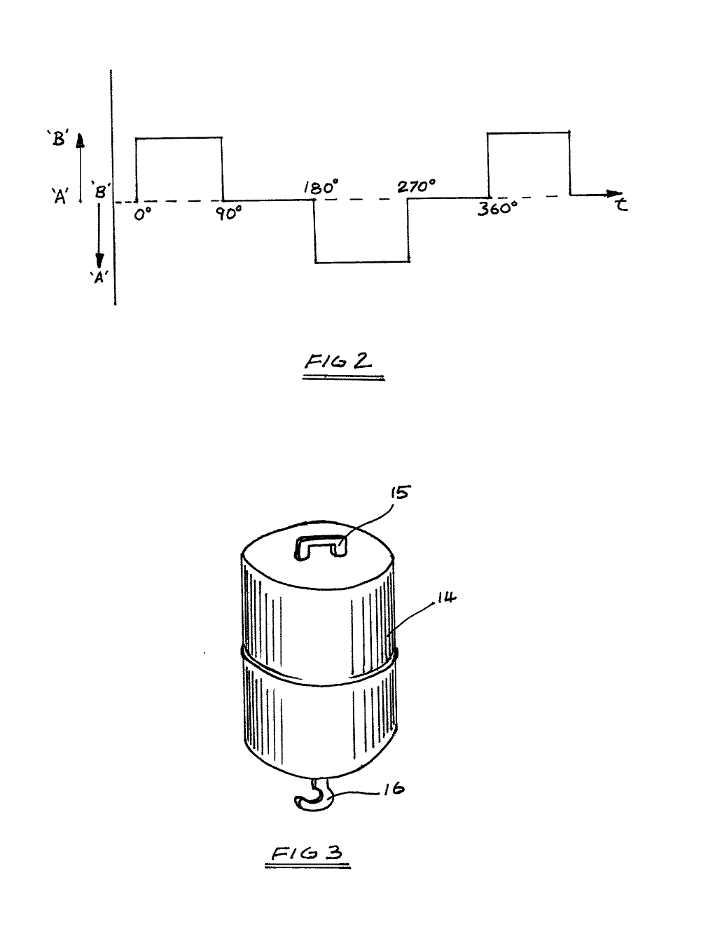

FIG. 2 is a diagrammatic representation of alternating drive pulses used in the arrangement of FIG. 1;

FIG. 3 is a perspective view of a display device for hanging from an object such as the branch of a Christmas tree;

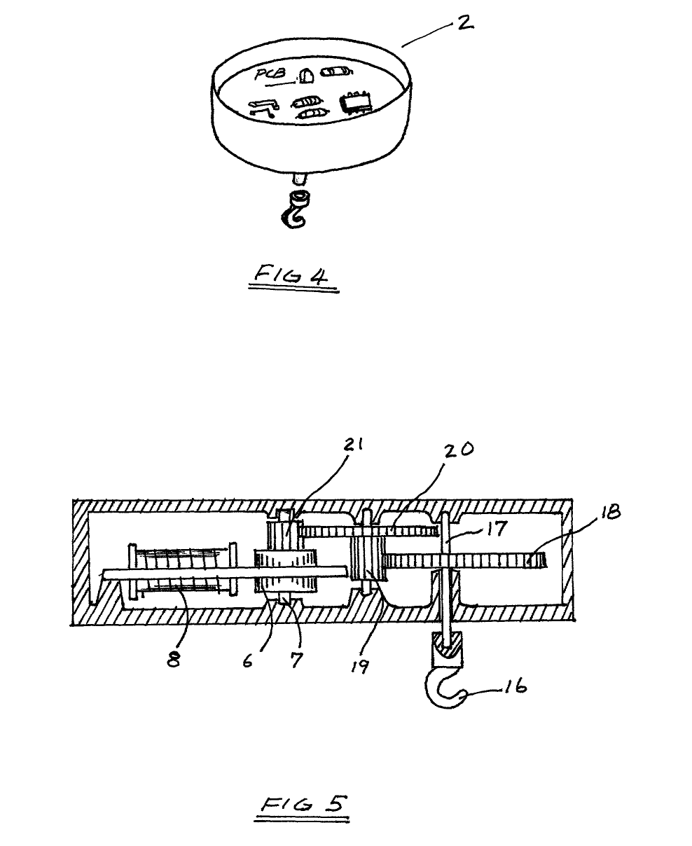

FIG. 4 is a detailed view of the lower part of the device of FIG. 3;

FIG. 5 is an enlarged cross-sectional view of part of the device shown in FIG. 4;

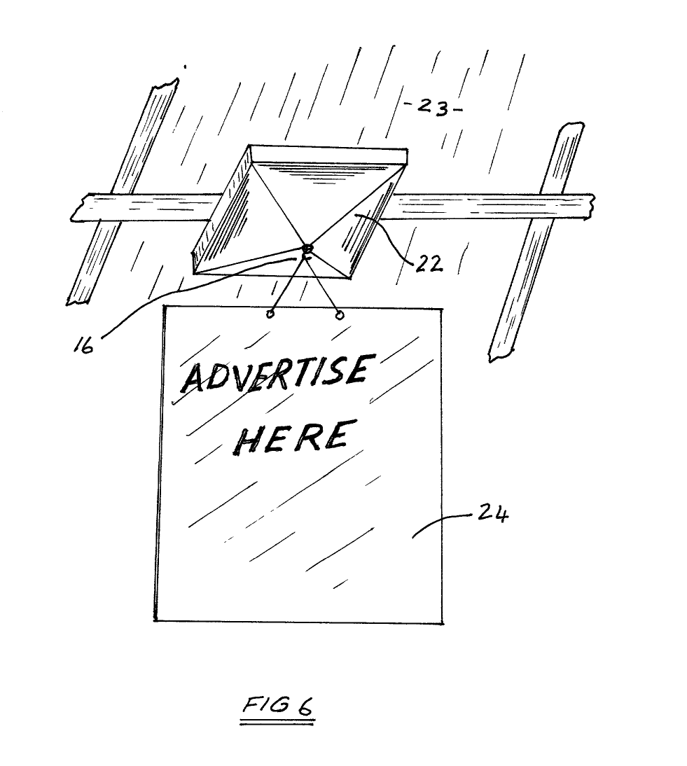

FIG. 6 is a view of a second embodiment of a display device adapted to be secured to a ceiling and shown in situ;

FIG. 7 is a perspective view of a third embodiment of a display device adapted to rest on a horizontal surface;

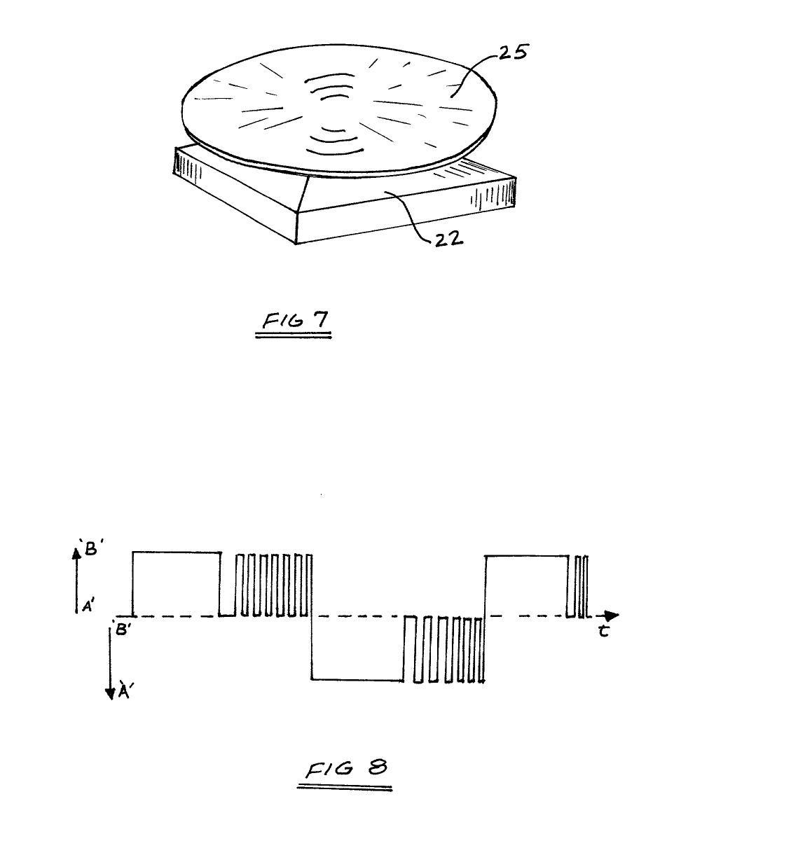

FIG. 8 shows diagrammatically a variation of the pulse train depicted in FIG. 2; and

Turning firstly to FIG. 1 there is depicted a schematic view of a stepper motor shown generally at 1 and a drive circuit therefor shown generally at 2 powered by a 1.5 v battery (not shown). The stepper motor 1 comprises a generally “U” shaped soft iron armature 3 having a pair of partly arcuate pole pieces 4,5.

Between the pole pieces 4,5 is a bi-polar magnetic rotor 6 having a centrally disposed spindle or drive shaft 7 which may be drivingly connected via a spur gear to a gear train (not shown).

Mounted on the pole piece 4 is a coil 8 of conventional configuration and comprising windings of insulated copper wire connected at respective ends “A” and “B” to the drive circuit 2.

The drive circuit 2 includes a drive pulse timing generator 9 for determining the drive pulse rate and the drive pulse duration, a control logic circuit 10 for switching the “H” bridge driver in the correct sequence and an “H” bridge driver 11 for switching drive pulses between “A” and “B” to the coil 8.

The timing generator 9 includes pre-settable trimming resistors for pre-adjustment of the drive pulse duration 12 and the drive pulse frequency 13, such that these two parameters can be pre-set to a desired level, which may be achieved empirically taking into account factors such as gearing ratios, frictional forces and required output speed of the display device.

The operation of the stepper motor 1 and its associated drive circuit 2 is illustrated schematically with reference to FIG. 2, depicting rotation of the rotor 6 through 360° over time as well as the timing and duration of drive pulses delivered to the coil 8.

Initially, the rotor 6 is activated through the application of a drive pulse to the coil 8 which thereby energises the pole pieces 4,5 in oppositely disposed north/south magnetic orientation which, in turn, forces the poles of the rotor 6 to seek their respective opposite pole on the stator 3. As the magnetic poles of the rotor 6 pass the 90° point of rotation relative to the major plane between the magnetic poles generated on the pole pieces 4,5 by the initial pulse of electrical energy to the coil 8, such that the poles on the rotor 6 begin to align themselves with the opposite poles on the pole pieces 4,5, the drive pulse is turned off and the rotor 6 is allowed to freewheel for 90° such that the poles on the rotor 6 are then past the opposite poles that would have been present on the pole pieces 4,5 if the pulse had been continuous.

At this point it will be understood that the rotor, by virtue of its initial rotation and hence its inertia is still rotating and a drive pulse is therefore applied to the coil in the opposite direction to the first pulse, thereby causing the rotor 6 to continue its movement towards the other pole piece, and so on. This effectively produces a flywheel motion where energy is pumped into the system in short bursts, just sufficient to maintain the inertia of the rotor 6 and hence with minimal battery consumption.

This may be contrasted to the conventional use of stepper motors which usually require the magnetic poles of the rotor to stop at each pole piece until the next pulse of energy is delivered, which therefore requires energy in both moving the poles apart initially and in slowing down the rotor as it comes into alignment with the magnetically opposite stator pole position.

Hence, in accordance with the invention, the drive pulses are not applied for the full 180° of rotor rotation between opposing magnetic poles, as is conventionally the case with stepper motors, but is delivered only between a predetermined rotational angle beyond the 90° mid-point of rotation and is then cut off before the rotor reaches the full 180° point at which the opposite poles are aligned. As such, as the poles of the rotor freewheel into alignment with opposite poles on the stator 3 no magnetic force slows the rotor movement such that it effectively “freewheels” with short bursts of electrical energy being applied to continue with the required rotational speed, thereby prolonging the operational life of the battery.

In FIG. 3 there is shown display device in the form of a Christmas ornament rotator 14 fitted internally with a motor, attendant gearbox and battery (not shown) as described in FIG. 1. The rotator 14 is in the form of a short cylinder on the top end of which is a staple 15 by which the rotator 14 may be tied to e.g. the branch of a Christmas tree, and oppositely disposed thereto is a rotatable hook 16 onto which may be hung a Christmas ornament.

In FIG. 4 there is shown a part cut-away lower section of the rotator 14 shown in FIG. 14 showing how the drive circuit 2 may be positioned in such a device.

FIG. 5 is an enlarged part-sectional view of the mechanical arrangement of the various moving parts in which it will be seen that the hook 16 is mounted on a spindle 17 to which is fixed for rotation a large diameter spur gear 18 in mesh with a small diameter gear 19 fixed for rotation with another large diameter spur gear 20 itself in mesh with a small diameter gear 21 fixed for rotation with the spindle 7 extending through the rotor 6. As will be apparent, high speed rotation of the rotor 6 drives the gear train defined by gears 18,19,20 and 21 to rotate the hook 16 relatively slowly, typically by a factor of 400 400 revolutions to 1. The hook 16, in this embodiment, constitutes a display support element for supporting, typically, a Christmas ornament.

In an alternative embodiment shown with reference to FIG. 6 the display device may have a housing 22 of say, pyramidal form such that the base thereof may include an adhesive pad (not shown) to, in this instance, secure the display device to a ceiling structure shown generally at 23. Depending from the housing 22 is a hook 16 onto which an advertising sign 24 may be hung, for rotation about a substantially vertical axis.

In a still further embodiment of the invention, the display device shown in FIG. 7 again shows a housing 22 of pyramidal form, but this time it is intended to rest upon a flat surface and instead of a hook 16 there is provided instead a display support element in the form of a turntable 25 which may be used to display and rotate e.g. jewellery and the like.

Reverting to FIG. 2, it will be seen that in its most simplistic form the invention provides that electrical drive pulses are continuous in that each pulse for each half rotation of the rotor 6 starts and finishes in a continuous manner. However, in practice it has been found that battery life of a display device according to the invention may be further extended by arranging, as shown in FIG. 8, for these pulses to be subdivided into a main drive pulse followed by a number of progressively shorter micro-pulses as the poles of the rotor 6 approach their respective opposite poles on the stator 3. It will be understood that the spacing between the main pulse and the succession of mini-pulses represents a saving in electricity and hence prolongation of the life of the battery.

In all embodiments of the invention, further savings in battery life can be achieved by the use of a photo resistor to turn the display device off when ambient light conditions fall below a predetermined level e.g. when the lights of a store are switched off.

1. A battery operated lightweight display device comprising or including a housing containing an electrically operable stepper motor, the stepper motor including a magnetic rotor, the rotor having single or multiple magnetic pole pairs, a bi-polarisable stator and associated coil; a drive circuit for driving the stepper motor at high speed by means of discrete electric drive pulses; a gear train drivingly connected between the rotor and a rotatable display support element; the display support element being adapted to support an object to be displayed and rotated relative to said housing when the drive circuit and hence the stepper motor is energised by a battery.

2. A display device according to claim 1 wherein the drive circuit is in the form of a micro-circuit including an “H” bridge driver for sending drive pulses to respective ends of the motor's coil to drive the rotor.

3. A display device according to claim 1 or claim 2 wherein the rotor is a single pole pair or multiple pole pair ferrite annular rod having a centrally disposed output drive shaft.

4. A display device according to any preceding claim wherein each drive pulse is subdivided into a main drive pulse followed by one or more micro-pulses.

5. A display device according to claim 4 wherein each drive pulse is subdivided into a main pulse to “kick” the rotor to a position approximately half way from one pole towards the next succeeding, but opposite, pole followed by a series of mini-pulses of decreasing duration as the rotor moves towards that pole.

6. A display device according to any preceding claim wherein the drive circuit includes an adjustable timing mechanism for controlling the frequency and duration of the drive pulses.

7. A display device according to any one of claims 1 to 5 wherein the frequency of the drive pulses is preset to maintain after start-up a supply of drive pulses only sufficient to keep the rotor turning at a constant and relatively high speed relative to the display support element but not at maximum possible speed, thereby to minimise excess consumption of electrical energy.

8. A display device according to any preceding claim wherein the display support element is a hook onto which an object to be displayed is hung.

9. A display device according to any preceding claim wherein the housing includes a self-adhesive pad for suspending the display device from a planar surface such as a ceiling.

10. A display device according to any one of claims 1 to 9 wherein the display support element is a turntable onto which an object to be displayed is placed.
